(19) United States
(12) Patent Application Publication
(10) Pub. No.: US 2009/0179342 A1
(43) Pub. Date: Jul. 16, 2009

(54) Process for In-molding Labels onto Plastic During a Hybrid Thermoforming-injection Molding Process

(76) Inventors: Pedro Jorge Pinto Oliveira Araujo, (US); Pedro Miguel Gomes de Sa, (US)

Correspondence Address: Law Offices of Mark E. Wiemelt, P.C., Suite 3300, 10 S. LaSalle Street, Chicago, IL, 60603, US

(21) Appl. No.: 12/013,430

(22) Filed: Jan. 12, 2008

(51) Int. Cl. B29C 45/16; B29C 51/16

(52) U.S. Cl. 264/161; 264/250

(57) ABSTRACT

A hybrid thermoform-injection molding process for fusing labels during the molding process onto plastic parts having multiple contours and/or holes, different wall thickness and depths is presented. In the preferred embodiment, a label made of the same material as the plastic piece to which it is to be applied is fixed into a shape corresponding to that of the final desired shape through thermoforming. The label is then placed into a second mold where it is fused to plastic in an injection molding process to form a final product.

### I. TECHNICAL FIELD OF THE INVENTION

The present invention generally relates to the in molding of labels onto plastic pieces and more particularly to a process for in-molding labels onto plastic parts of varied shapes, wall thickness, sizes, and contours using a hybrid thermoforming-injection molding process.

### II. BACKGROUND OF THE INVENTION AND PRIOR ART

Molding plastic pieces, particularly those of irregular shape and configuration can be an intricate and complex undertaking. For example, in the molding of plastic parts for motorcycles there are many irregularly shaped pieces, such as radiator scoops, or pieces of irregular shape and have holes in them, such as for areas requiring ventilation.

It is also necessary that in many instances the plastic used must be of a rugged and durable nature yet flexible. Again, in the case of motorcycle parts it is generally desirable that the parts be made of a plastic that can withstand tremendous forces without breaking and must be resilient enough to withstand undue scratching and chipping.

Due to these requirements, polypropylene plastic is often employed. Polypropylene is a robust plastic used in everything from plastic bottles to carpets to plastic furniture, and is very heavily used in automobiles and motorcycles.

Polypropylene is partially crystalline and partially amorphous in molecular structure, giving it both a melting point (the temperature at which the attractive intermolecular forces are overcome) and a glass transition (temperatures above which the extent of localized molecularization is substantially increased). It is found in the group of plastics that include, among others, polyethylene, poly vinyl chloride, polyamides (nylons), polyesters and some polyurethanes.

When molding polypropylene, several methods can be used. One popular method is thermoforming. Typically, polypropylene parts are molded through thermoform molding. Thermoforming is a process of forming a thermoplastic sheet into a three-dimensional shape by clamping the sheet in a frame, heating it to render it soft and pliable, then applying differential pressure to make the sheet coliform to the shape of a mold or die positioned below the frame. When the pressure is applied entirely by vacuum, the process is called vacuum forming. When air pressure is employed to partially preform the sheet prior to application of vacuum the process becomes air-assist vacuum forming. In another variation, mechanical pressure is applied to a plug to partially preform the sheet (plug assist forming). In the drape forming modification, the softened sheet is lowered to drape over the high points of a male mold prior to application of vacuum. Still other modifications are: plug-and-ring forming—using a plug as the male mold and a ring matching the outside contour of the finished article, ridge forming—the plug is replaced with a skeleton frame, slip forming or air slip forming—the sheet is held in pressure pads which permit it to slip as forming progresses, bubble forming—the sheet is blown by air into a blister and then pushed into a mold by means of a plug. Thermoforming also includes methods employing only mechanical pressure, such as matched mold forming, in which the hot sheet is formed between registered male and female molds.

There are two general thermoforming process categories. Sheet thickness less than 1.5 mm (0.060 inches) is usually delivered to the thermoforming press in rolls. Thin gauge roll fed thermoforming applications are dominated by rigid or semi rigid disposable packaging. Sheet thickness greater than 3 mm (0.140 inches) is usually delivered to the forming press cut to final dimensions and stacked on pallets. Heavy or thick gauge, cut sheet thermoforming applications are primarily used as permanent structural components. There is a small but growing medium gauge market that forms sheet 1.5 mm to 3 mm in thickness. Heavy gauge forming depends on convection oven heating of the sheet and draping of the sheet over male, female or paired molds. Heavy gauge parts are used as cosmetic surfaces on permanent structures such as automobiles, refrigerators, spas and shower enclosures, and electrical and electronic equipment.

Another popular molding technique is injection molding. In this method, the basic cycle is: 1) close Mold, 2) injection carriage forward, 3) inject plastic, 4) metering, 5) retract carriage, 6) open mold, and 7) eject part(s). Resin, or raw material for injection molding, is usually in pellet or granule form, and is melted by heat and shearing forces shortly before being injected into the mold. After injection into the mold, the resin is held in place by the mold shape until it is sufficiently hardened that the plastic part can be extracted from the mold.

In making parts, it is often desirable to decorate them in some fashion. This is usually accomplished by placing labels, or stickers, on the part. Traditionally, labels have been affixed to the exterior surface of a plastic piece after the piece has been molded. Among the many shortcomings of the prior art are that labels become easily scratched; there is not a solid bond between the label and the plastic part resulting in peeling; the label is subject to UV rays and, therefore, to fading; and, the part is not recyclable for the reason that the labels are not compatible with the underlying plastic piece. Additionally, there is added cost to the process of applying the label since it must be handled once for the molding process and a second time to add the label.

The process of in molding labels has addressed many of the concerns associated with labels. In general, in molding is a process in which labels or other decorative pieces are molded directly to the plastic part during the molding process. However, until the present invention in molding techniques have generally required that a plastic piece, or an area of a plastic piece, to which a label is to be molded be flat, or nearly flat, or uniformly round, such as a bucket, and be of a regular shape and without holes. Additionally, molds have generally included a cavity in the desired location of the label placement in which the label is placed. This has limited the use of in molding for the application of labels. Another shortcoming of the prior art is that labels are limited in the size that can be applied to a plastic piece. Until the present invention, it has not been possible to place full size labels onto a plastic piece during the in mold process on these kind of plastics parts (size, shape and material).

The reason for the foregoing shortcomings is that until the present invention, accurate label placement and the ability to hold a label in place during molding has been limited. In general, prior art in molding techniques have relied upon an electrical charge applied to the back of a label to transfer and hold the label in place on a mold. While an electrical charge is beneficial in label placement, charging the back of a label has limited the ability to transfer and hold labels in place on contoured surfaces or those with holes as the labels are prone to slip, thereby resulting in an unacceptable level of rejected pieces.

There is need, therefore, for a process in which labels can be permanently bonded to plastic parts of varied contours or with holes and different wall thickness in them such that the labels adhere to the plastic part, resist fading, scratching, and peeling, are recyclable, and is economical.

### III. OBJECTS OF THE INVENTION

It is an object of the present invention to provide an in molding process that enables the placement of labels onto plastic parts of varied contours or with holes in them during the molding process.

It is a further object of the present invention to provide an in molding process in which labels are thermoformed into the shape of the desired part prior to placement on a plastic piece.

It is yet a further object of the present invention to provide a molding process in which labels can be placed with commercially accepted accuracy onto plastic pieces of any shape or contour or with holes in them.

It is a further object of the present invention to provide an in molding process in which a thermoform shaped label is fused to a plastic piece through injection molding techniques.

It is a further object of the present invention to provide an in molding process in which labels resist fading, scratching, and peeling.

It is yet a further object of the present invention to provide such a process that is cost effective.

### IV. SUMMARY OF THE INVENTION

The foregoing objects of the invention are provided for in an inventive process for in molding labels onto plastic parts of varied contours and/or with holes in them during the molding process. According to the invention, a label having art work that is made using inks that are resistant to thermoforming stretching is positioned onto a mold and, through a thermoforming molding process molded into the shape corresponding to that of the final finished plastic piece. The now thermoformed label is then trimmed and relocated into the mold of the final plastic piece where it fits into the contours of the mold . . . . Placement is accomplished manually or through the use of a robotic arm.

Then, in the normal in injection molding fashion, plastic resin of the same composition as the label is placed over the thermoformed shaped label. In the preferred embodiment, polypropylene is used for the label and the plastic layer.

Thus, a finished plastic piece is created which can be partially or fully decorated on its outer surface.

There has been outlined, rather broadly, the more important features of the invention in order that the detailed description thereof that follows may be better understood, and in order that the present contribution to the art may be better appreciated. There are, of course, additional features of the invention that will be described hereinafter and that will form the subject matter of the invention.

For non-limiting example, while the specification focuses on polypropylene plastic, those skilled in art will quickly realize that the process disclosed herein will work with a variety of plastics. As such, those skilled in the art will appreciate that the conception, upon which this disclosure is based, may readily be utilized as a basis for designing of other structures, methods, and systems for carrying out the several purposes of the present invention. It is important, therefore, that the claims be regarded as including such equivalent constructions in so far as they do not depart from the spirit and scope of the present invention.

Further, the purpose of the abstract is to enable the US Patent and Trademark Office and the public generally, and especially the scientists, engineers and practitioners in the art who are not familiar with the patent or legal terms or phraseology, to determine quickly from what cursory inspection the nature and essence of the technical disclosure of the application. The abstract is neither intended to define the invention of the application, which is measured by the claims, nor is it intended to be limiting as to the scope of the present invention in any way.

These together with other objects of the present invention, along with the various features of novelty which characterize the present invention, are pointed out with particularity in the claims annexed to and forming a part of this disclosure. For a better understanding of the present invention, its operating advantages and the specific objects attained by its uses, reference should be had to the accompanying drawings and descriptive matter in which there is illustrated a preferred embodiment of the present invention.

### V. BRIEF DESCRIPTION OF THE DRAWINGS

FIG. 1 is a flow chart depicting the method flow of the preferred embodiment.

FIG. 2 is a top perspective view of a label being placed into a thermoform mold.

FIG. 3 is a top perspective view of a label being trimmed after the thermoform molding process.

FIG. 4 is a top perspective view of a label being placed into the injection mold.

FIG. 5 a flow chart illustrating the injection molding process.

FIG. 6 illustrates an example of a sticker placed on the outside wall of the plastic piece after molding partially decorating a finished piece.

FIG. 7 illustrates an example of a sticker placed on the outside wall of the plastic piece after molding fully decorating a finished piece.

### VI. DETAILED DESCRIPTION OF THE INVENTION

Before explaining the preferred embodiment of the present invention in detail, it is to be understood that the present invention is not limited in its application to the details of construction and to the arrangements of the components set forth in the following description or illustrated in the drawings. The present invention is capable of other embodiments and of being practiced and carried out in various ways. Also, it is to be understood that the phraseology and terminology employed herein are for the purpose of description and should not be regarded as limiting. And while the disclosure focuses on motorcycles parts, this should in no manner be considered limiting. The method will work for any plastic piece which would benefit from the inventive method.

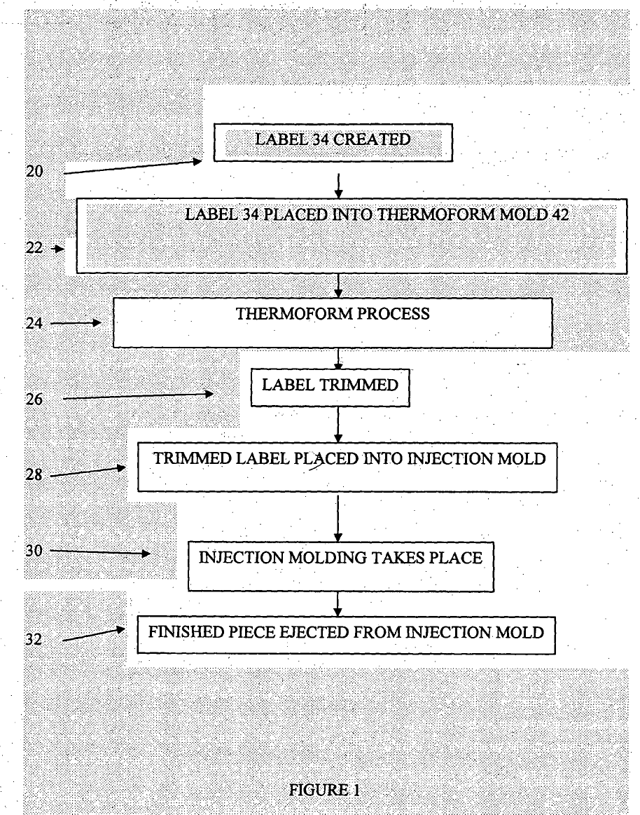

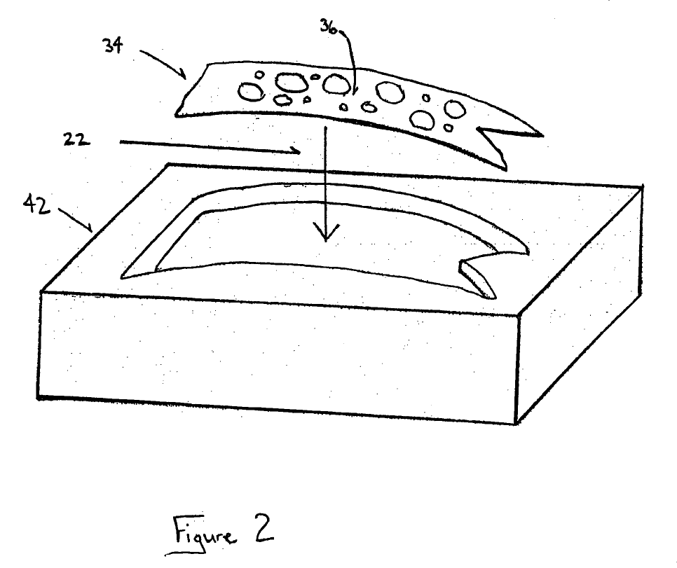

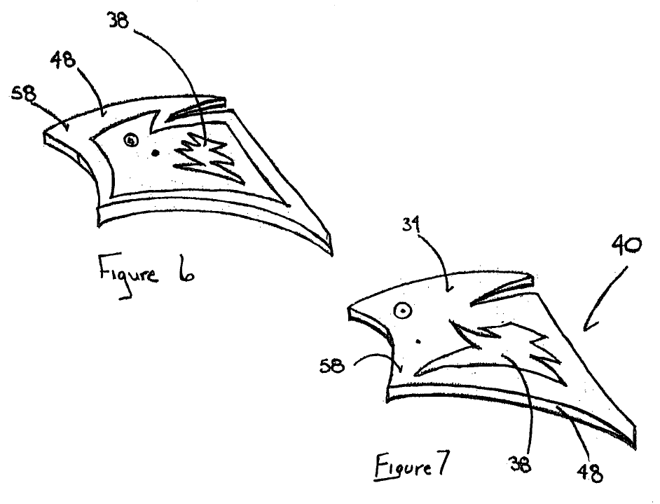

Turning to FIG. 1, a flow chart depicting the inventive process is shown. At 20, label 34, as seen in FIG. 2, is created. The inventors have found that the use of polypropylene plastic works best for the reasons that it is a tough and flexible material that is well suited to complex molding, although any material that retains its shape during and after the molding process is suitable for use. Non-limiting examples of commonly used materials are polystyrene (a low cost material that lacks the strength and longevity of most other plastics), ABS or acrylonitrile butadiene styrene (a co-polymer or mixture of compounds used for everything from toy parts to electronics housings), nylon (chemically resistant, heat resistant, tough and flexible), polyethylene, polyvinyl chloride or PVC (commonly used for pipes, window frames, or as the insulation on wiring where it is rendered flexible by the inclusion of a high proportion of plasticizer), and polypropylene (tough and flexible, it is used for everything from containers to heavy parts for automobiles and motorcycles). The decorative features A of label 34 are created using thermoforming stretching resistant inks. The ink is placed on the inside 36, that is the side of the label that will be in contact with the plastic of finished product 40, as depicted in FIGS. 6 and 7. Once the decorative features are applied label 34 is placed 22 into thermoform mold 42 (FIG. 2). As seen in FIG. 2, the mold into which label 34 is placed has a shape corresponding to that of finished plastic piece 40. After placement, label 36 undergoes a thermoform process 24 in any customary manner.

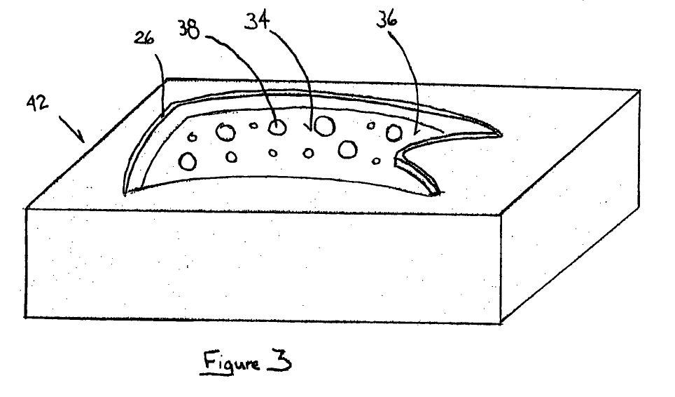

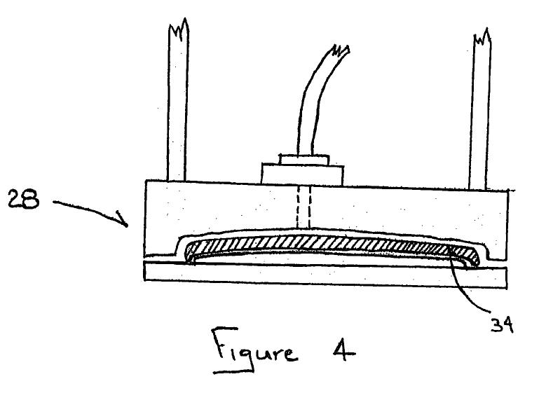

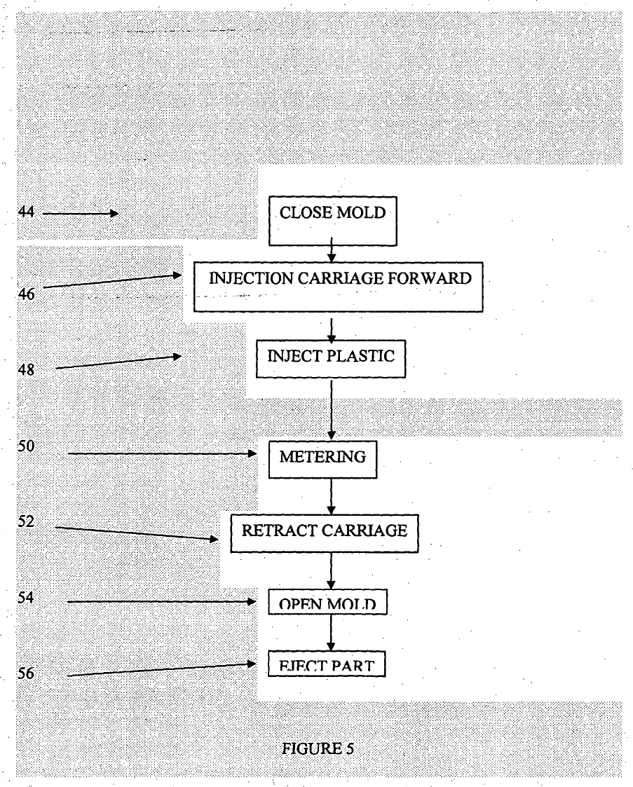

Turning back to FIG. 1, after label 34 is shaped using the thermoformed process, it is trimmed 26 so that excess plastic is removed. Label 34 is trimmed, as depicted in FIG. 3, so that it fits precisely into the mold for the injection molding of final finished piece 40. After trimming, label 34 is placed into the injection molding mold 28 (FIG. 4) whereafter finished piece 40 is created through customary injection molding techniques 30 and then finished piece 40 is ejected from the mold 32. FIG. 5 illustrates a typical injection molding process wherein the basic cycle is: 44) close Mold, 46) injection carriage forward, 48) inject plastic, 50) metering, 52) retract carriage, 54) open mold, and 56) eject part(s).

FIGS. 5 and 6 show examples of plastic part 40 in the form of a side panel for a motorcycle. As can be seen, plastic part 40 is of irregular shape and has many contoured surface angles. In the manufacture of irregular shaped pieces, a single piece may have several wall thicknesses found throughout its full shape and body. Variations in wall thickness cause an irregular plastic flow, thus becoming a barrier to inmold decoration. As a result, until the present invention, inmold techniques have been used only on uniform thickness pieces. FIG. 5 illustrates an example of a finished piece having a label 34 which only partially cover the surface 58 of finished piece 40. FIG. 6 illustrates an example of a finished piece in which the entire surface 58 is covered with label 40.

Prior art in molding have not been used successfully in complex geometry settings, especially in the case of covering the entire surface of a finished piece with a label, for the reason that until the present invention, there has not been a suitable and economical way to apply a label and hold in place for the molding process. Applicants' inventive process, overcomes these shortcomings in plastic pieces of complex geometry or that have holes in them on several levels. First, label 34, through shaping in the thermoforming process, can be accurately positioned on the injection mold and held in place where it is then fused through the inventive process to plastic layer 38, thereby creating a bond between the label and plastic. Testing has demonstrated that polypropylene is superior over other plastics in this regard as other plastics do not have as good of a bond between the label and the plastic layer as is seen with polypropylene.

Second, the inventive method enables indicia markings 36 to be placed on the interior surface 36 of label 34, thereby significantly reducing the opportunities for the markings to be scratched off, chipped, ripped, or peeled from the plastic layer. The inventive process also creates a product that is less susceptible to be damaged under UV radiation, high resistance to scratch, thus making the markings fade resistant.

Central to the inventive process is that the label 34 and plastic layer 38 are made of the same material. Owing to this fact, those skilled in the arts will quickly realize that any plastic suitable for the needs required of a finished product will work and still be within the spirit and scope of the invention. Further, due to the fact that the label and the plastic layer are made of the same material, the finished product is also environmental sound in that it can be recycled; unlike much of the prior art which typically are made of incompatible materials not suitable for recycling.

Those skilled in the arts will recognize that the above described process may be varied depending on equipment and molding needs. So long as the label film is properly positioned and the plastic layer is injected and the label film and the plastic layer are subjected to sufficient heat, the order and number of steps is not critical.

With regards to the characteristics of label 34, it is, as stated above, made of the same material as plastic layer 38 and preferably should be a plastic foil preferably of a thickness of about 700 μm, with a range of about 300 μm up to about 1 m. The Inventors have discovered that thickness below 130 μm result in label bending, making it difficult to adjust properly to the shape of the part. Also, thickness below 300 microns is very difficult to thermoform contoured pieces correctly. Take in account the high depth of the parts, could be up to 12 cm. The correct bond to plastic 38 is related to label 34 characteristics. The thickness has a higher influence on the label performance to adjust to a 3D shape. If the label is not correctly shaped, fusion is affected. However, it is to be understood that the label thickness is not critical to the inventive process. As those skilled in the arts will quickly understand, label thickness will be dependent upon many factors including but not limited to temperature, metering time, molding process, and quality and skill of molding equipment and workman.

Experimentation by the Inventors has revealed that temperatures in the range of about 190° C. to about 340° C. works best in causing a good fusion of label film and plastic layer during the injection molding phase of the process. For Poly propylene, the inventors work with 200° C. up to 255° C. depending on the part. However, it is to be understood that the temperature is not critical to the inventive process. As those skilled in the arts will quickly understand, temperature will be dependent upon many factors including but not limited to label thickness, metering time, molding process, thickness of the plastic layer, its size, shape and contours, and the size characteristics of the label and quality and skill of molding equipment and workman. The temperature must be high enough to cause the fusion but not so high as to destroy the properties of either the label or plastic layer.

One of the benefits of the inventive process is that, unlike the prior art, no cavity is required to be built into a mold to accommodate a label. Accordingly, a mold with no label cavity can be used to form a finished product.

Applying the inventive process results in a fully decorated plastic part 40 when it is ejected from the mold. The inventive process results in superior product produced in a time efficient and economical approach in that the label is added to the plastic layer in the molding process as opposed to a second procedure made necessary by prior art techniques.

It is to be understood, however, that even though numerous characteristics and advantages of the preferred and alternative embodiments have been set forth in the foregoing description, together with details of the structure and function of the embodiments, the disclosure is illustrative only, and changes may be made in detail, especially in matters of shape, size and arrangement of parts within the principles of the invention to the full extent indicated by the broad general meaning of the terms in which the appended claims are expressed. It is also to be expressly understood that while the invention is described as having steps, the order of the steps is not critical. For instance, trimming may be done on the final finished piece as well as in the described thermoforming phase of the process. So long as a shaped label is created which can then be fused to a plastic piece is created, the scope and spirit of the invention will be embodied in the final product.

We claim:

1) A process for molding a label into plastic parts comprising the steps of:
creating a label having a front surface and a back surface;
placing the label in a thermoform mold so that the label back surface is against the thermoform mold;
molding the label to the shape of the mold;
trimming the label to remove excess material;
placing the label into an injection mold, the injection mold having a corresponding to that of the thermoform mold; and,
injecting plastic into the mold, thereby fusing the label to the plastic.

2) The process of claim 1 wherein the label is made of a material selected from polystyrene, acrylonitrile butadiene styrene, nylon, polyethylene, polyvinyl chloride, and polypropylene

3) The label of claim 1 wherein the label is polypropylene.

4) The process of claim 1 wherein the plastic is made of a material selected from polystyrene, acrylonitrile butadiene styrene, nylon, polyethylene, polyvinyl chloride, and polypropylene

5) The label of claim 1 wherein the plastic is polypropylene.

6) The process of claim 1 wherein the label and the plastic are made of the same material.

7) The process of claim 1 wherein the label includes decorative features, the decorative features composed of thermoform stretch resistant material.

8) The thermoform stretch resistant material of claim 7 being ink.

9) The manufacturing method of claim 1 including the further step of using an injection temperature in a range of about 190° C. to about 340° C.

10) The manufacturing method of claim 1 including the further step of using a label of between 300 μm and limn in thickness.

11) The label film of claim 3 wherein the label thickness is 700 μm.

12) A process for molding a label into plastic parts comprising the steps of:
creating a label having a front surface and a back surface;
shaping the label to a fixed shape and contour corresponding to a desired final shape and contour;
fusing the label to plastic in a shape and contour of the desired final shape and contour.

13) The process of claim 12 wherein the label is shaped through a molding process.

14) The molding process of claim 13 being thermoforming.

15) The process of claim 12 wherein the label is made of a material selected from polystyrene, acrylonitrile butadiene styrene, nylon, polyethylene, polyvinyl chloride, and polypropylene.

16) The process of claim 12 wherein the plastic is selected from polystyrene, acrylonitrile butadiene styrene, nylon, polyethylene, polyvinyl chloride, and polypropylene

17) The process of claim 12 wherein the label and the plastic are made of the same material.

18) The process of claim 12 wherein the label is fused to the plastic through a second molding process.

19) The second molding process of claim 17 being injection molding.

20) The process of claim 12 wherein the label includes decorative features on the front surface, the decorative features composed of thermoform stretch resistant material.

21) The manufacturing method of claim 12 including the further step of using an injection temperature in a range of about 190° C. to about 340° C.

22) The manufacturing method of claim 12 including the further step of using a label of between 300 μm and 1 mm in thickness.

23) The label film of claim 3 wherein the label thickness is 700 μm.
